(19) United States
(12) Patent Application Publication
(10) Pub. No.: US 2025/0088995 A1
(43) Pub. Date: Mar. 13, 2025

(54) METHOD TO TRACK VARIOUS ATTACH TYPES ON UDM & UDR

(71) Applicant: T-Mobile Innovations LLC, Overland Park, KS (US)

(72) Inventors: Anil Kumar MARIYANI, Ashburn, VA (US); Subramania KAUSHIK, Bellevue, WA (US)

(21) Appl. No.: 18/464,527

(22) Filed: Sep. 11, 2023

(51) Int. Cl. H04W 60/04; H04W 8/18

(52) U.S. Cl. CPC H04W 60/04; H04W 8/183

(57) ABSTRACT

Systems and methods are provided for tracking handover types in a wireless network. An originating radio access technology (RAT) and a destination radio access technology (RAT) are determined from the initial request from a UE to attach to the wireless network. The originating RAT and destination RAT for the initial attach request are transmitted and maintained in a subscriber profile associated with the wireless device for subscriber tracking and network analysis.

### TECHNICAL BACKGROUND

A wireless network, such as a cellular network, can include an access node (e.g., wireless access node) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)).

Further, different types of access nodes may be implemented for deployment for the various RATs. For example, a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. With the variety of RATs in a wireless network, UEs experience handovers between RATs to improve the UE connection to the network.

### OVERVIEW

One aspect of the present disclosure relates to a system. The system may include one or more hardware processors configured by machine-readable instructions. The processor(s) may be configured to receive an initial attach request from a wireless device. The processor(s) may be configured to determine from the initial attach request an originating radio access technology (RAT) and a destination radio access technology (RAT) for the initial attach request. The processor(s) may be configured to transmit the originating RAT and destination RAT for the initial attach request to a subscriber profile associated with the wireless device.

In some implementations of the system, the processor(s) may be configured to generate a service based interface (SBI) HTTP2 message for 5G.

In some implementations of the system, the processor(s) may be configured to assign attributes for the initial attach request including a member, string value and value. In some implementations of the system, the processor(s) may be configured to transmit the SBI HTTP2 message to a unified data management of a mobile network operator. In some implementations of the system, the member may be handover type. In some implementations of the system, the string value may be handover.

In some implementations of the system, the processor(s) may be configured to update the subscriber profile for the wireless device maintained in a unified data repository with corresponding fields for the attributes for the initial attach request.

Another aspect of the present disclosure relates to a method. The method may include receiving an initial attach request from a wireless device. The method may include determining from the initial attach request an originating radio access technology and a destination radio access technology for the initial attach request. The method may include transmitting the originating RAT and destination RAT for the initial attach request to a subscriber profile associated with the wireless device.

Yet another aspect of the present disclosure relates to a non-transient computer-readable storage medium having instructions embodied thereon, the instructions being executable by one or more processors to perform a method. The method may include receiving an initial attach request from a wireless device. The method may include determining from the initial attach request an originating radio access technology and a destination radio access technology for the initial attach request. The method may include transmitting the originating RAT and destination RAT for the initial attach request to a subscriber profile associated with the wireless device.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1A depicts a wireless network that may be connected to and mobile device, in accordance with disclosed examples.

FIG. 1B depicts a wireless network that may be connected to and mobile device, in accordance with disclosed examples.

FIG. 2 depicts a wireless network and 5G core that may be connected to and mobile device, in accordance with disclosed examples.

FIG. 3 illustrates a system and an initial attach request tracking engine, in accordance with the disclosed examples.

FIG. 4 illustrates a method for transmitting originating and destination RAT from an initial attach request to subscriber profile in accordance with disclosed examples.

FIG. 5 illustrates a method for utilizing originating and destination RAT from an initial attach request from subscriber profile for network analysis in accordance with disclosed examples.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may include an electronic processor.

In a 5G core network, the Access, and Mobility Management Function (AMF) receives connection and session information from the User Equipment (UE). In 5G deployment based on 3GPP specifications, the AMF has ability to notify UDM/UDR of the 5G core whether a session is an initial attach vs non-initial attach. However, there currently is not a method for the AMF to notify the UDM/UDR of the 5G core about different handover types when there is an initial attach session.

Tracking engine of the AMF is configured to track new attributes with key values for the originating radio access technology (RAT) and the destination radio access technology (RAT) for initial attach requests. The originating RAT is the RAT where the UE was previously attached but due to inactivity or poor coverage, the UE has detached. The UE then sends a request to attach to a destination RAT. The UE may request to re-attach to the originating RAT or request to attach to a new RAT.

In examples, the tracking engine, upon receiving an initial attach request, generates a message with handover attributes for the wireless device. In examples, a service based interface (SBI) HTTP2 message is generated with attributes having key values assigned to identify the originating RAT and the destination RAT.

In examples, key values may be full text or unsigned 32 bit integer values as shown in Table 1 below.

TABLE 1

| Bit | Originating RAT to Destination RAT |
|---|---|
| Bit: 1 | 5G -> 5G Re-Attach |
| Bit: 2 | 4G -> 5G |
| Bit-3 | 5G -> 4G |
| Bit-4 | 5G -> 6G |
| Bit-5 | 6G -> 5G |
| Bit-6 | 4G -> 5G (Roaming) |
| Bit-7 | 5G -> 4G (Roaming) |
| Bit-8 | 5G -> 6G (Roaming) |
| Bit-9 | 6G -> 5G (Roaming) |
| Bit-10 | 5G -> Non-3GPP WiFi |
| Bit-11 | Non-3GPP WiFi -> 5G |

The tracking engine of AMF transmits the generated message with handover attributes (originating RAT and destination RAT) for the wireless device to the UDM/UDR of the 5G core. The UDM accepts the message and attributes and updates UDR with corresponding attribute fields. The UDM updates the subscriber profile for the UE with the originating RAT and destination RAT for the initial attach request.

The tracking engine of the AMF can generate messages with handover attributes for multiple initial attach request for a wireless devices. In addition, the tracking engine of the AMF can generate messages with handover attributes for multiple initial attach requests for multiple different devices creating a data repository for attributes for initial attach requests for a wireless network database. The data repository can be utilized for auditing and tracking individual subscriber coverage. In addition, on an operational level, the data repository for multiple subscribers can be utilized to generate network reports for handover and subscriber types. The database can be utilized to identify poor coverage areas due to frequent handovers and network coverage can be enhanced accordingly.

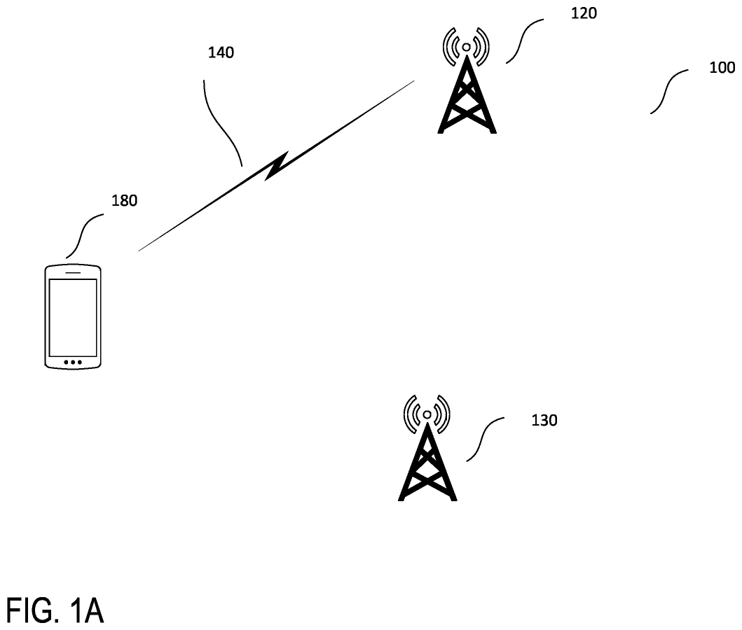

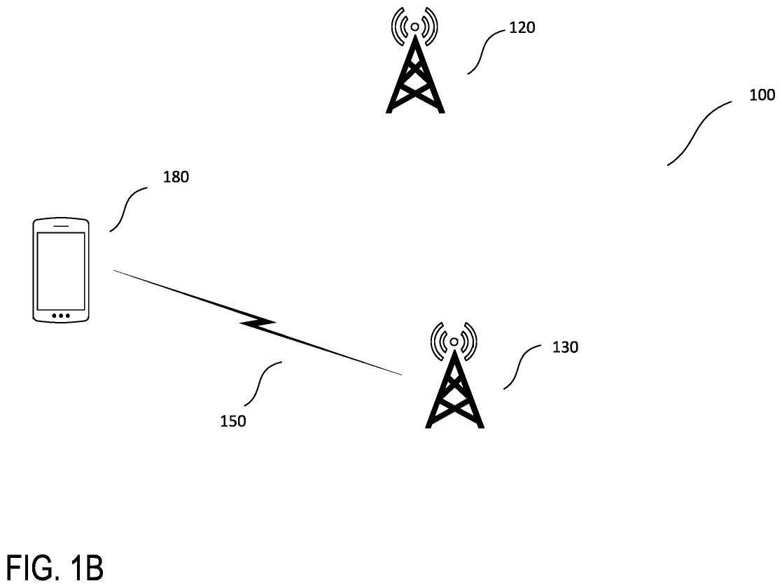

FIGS. 1A and 1B depict wireless environment 100 illustrating an access nodes 120 and 130. Wireless environment 100 includes a UE 180. The UE 180 may be a cell phone, mobile phone, wireless phone, as well as other types of devices or systems that are capable of radio frequency communication. UE 180 is capable of attaching to access node 120. Access nodes 120 and 130 may be operated by a Mobile Network Operator (MNO). While the wireless environment is depicted with a single UE 180, access nodes 120 and 130, it may comprise multiple UEs 180, and access nodes 120 and 130.

Access nodes 120 and 130 may be for a wireless network, such as a cellular network. The cellular network may include a core network and a radio access network (RAN) serving multiple UEs 180 in a geographical area covered by a radio frequency transmission provided by the wireless network. As technology has evolved, different carriers (MNOs) within the cellular network may utilize different types of radio access technologies (RATs). Access nodes 120 and 130 may utilize a single RAT or multiple RATs. RATs can include fifth generation (5G) RATs (new radio (NR)) and 6G. Further, different types of access nodes may be implemented within the access network for deployment for the various RATs. A next generation NodeB (gNB) may be utilized for 5G RATs. Deployment of the evolving RATs in a network provides numerous benefits. For example, newer RATs, such as 5G RATs, may provide additional resources to subscribers, faster communications speeds, and other advantages.

With reference to FIG. 1A, UE 180 may be attached 140 to access node 120. In an example, access node 120 utilizes a 5G RAT. The 5G RAT of access node 120 is the originating RAT. The UE was previously attached access node 120 but due to inactivity or poor coverage, the UE has detached.

With reference to FIG. 1B, subsequent UE 180 requests to attach 150 to access node 130. In the example, access node 130 requests to attach to a 4G RAT. The 4G RAT of access node 130 is the destination RAT.

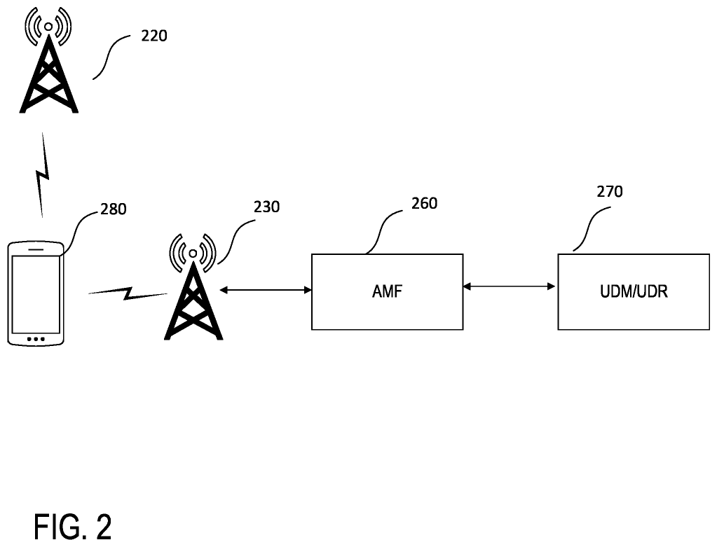

With reference to FIG. 2, a wireless environment 200 illustrating access nodes 220 and 230 is depicted. Wireless environment 200 includes a UE 280. The UE 280 may be a cell phone, mobile phone, wireless phone, as well as other types of devices or systems that are capable of radio frequency communication. While depicted as a single UE 280, it will be appreciated that there may be multiple UEs.

UE 280 was attached to access node 220 utilizing a 5G RAT. UE 280 has detached from the 5G RAT and has sent a request to attach to access node 230 utilizing a 4G RAT. The initial attach request is received at AMF 260. AMF 260 determines from the initial attach request the originating RAT was a 5G RAT and the destination RAT is a 4G RAT. AMF 260 generates a message with the originating RAT and the destination RAT. AMF 260 transmits the message to the UDM/UDR 270 of the 5G core.

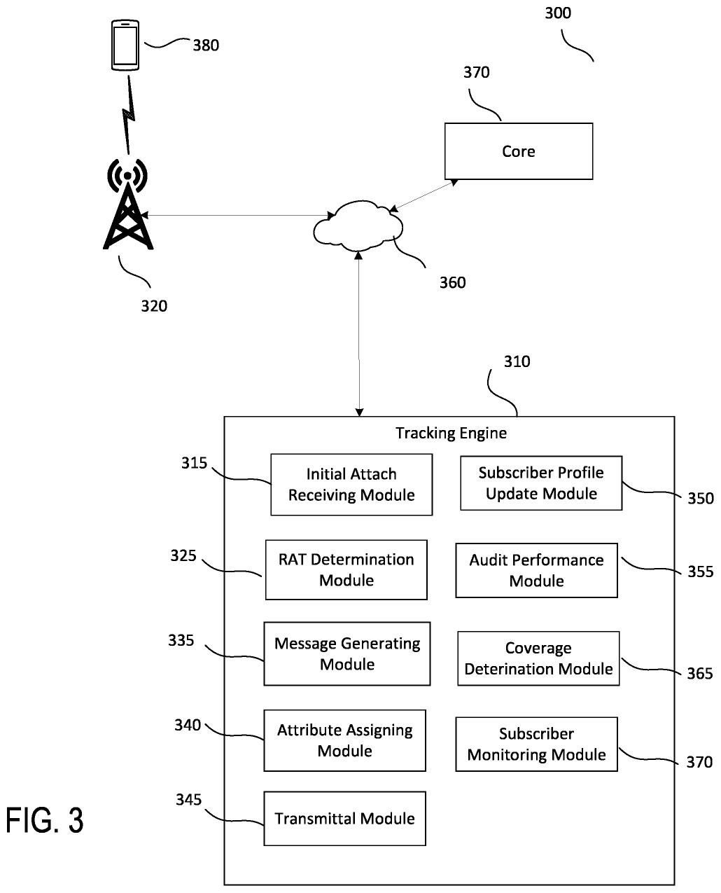

FIG. 3 illustrates a system 300 configured to track the originating RAT and destination RAT in an initial attach request in accordance with one or more implementations.

As illustrated, system 300 comprises tracking engine 310, an access node 320, a network 360, a 5G core 370, which provide service in a coverage area, a UE 380. For purposes of illustration and ease of explanation, only one access node 320 and one UE 380, and are shown in the system 300; however, as noted above with regard to FIG. 2, additional access nodes and/or additional local routers and UEs may be present in the system 300.

In the illustration of FIG. 3, the access node 320 is connected to the network 360 via an NR path (including the 5G core 370); however, in practical implementations the access node 320 may be connected to network 360 via multiple paths (e.g., using multiple RATs). The access node 320 may communicate with the core 370 via one or more communication links, each of which may be a direct link. However, it will be appreciated that network 360 may be any type of network facilitating communication among tracking engine 310, access node 320, core 370, and UE 380.

The access node 320 may be any network node configured to provide communications between the connected wireless devices. As examples of a standard access node, the access node 320 may be a gNodeB in 5G networks, an eNodeB in 4G/LTE networks, or the like, including combinations thereof. Access node 320 and core 370 may also provide data to tracking engine 310.

Tracking engine 310 is in communication with the access node 320 and/or the core 370. Tracking engine 310 may be configured to monitor the originating RAT and destination RAT for an initial attach request.

The tracking engine 310 can comprise one or more electronic processors and associated circuitry to execute or direct the execution of computer-readable instructions such as those described herein. In so doing, the connection optimization engine 310 can retrieve and execute software from storage, which can include a disk drive, a flash drive, memory circuitry, or some other memory device, and which may be local or remotely accessible. The software may comprise computer programs, firmware, or some other form of machine-readable instructions, and may include an operating system, utilities, drivers, network interfaces, applications, or some other type of software, including combinations thereof. Moreover, the tracking engine 310 can receive instructions and other input at a user interface.

As illustrated, the tracking engine 310 utilizes a modular controller, a memory, wireless communication circuitry, and a bus through which the various elements of the tracking engine 310 may communicate with access node 320, core 370, and UE 380. The modular controller is one example of an electronic processor, and may include sub-modules or units, each of which may be implemented via dedicated hardware (e.g., circuitry), software modules which are loaded from the memory and processed by the controller, firmware, and the like, or combinations thereof. In examples, tracking engine 310 may be controlled by the processor of a wireless access node and/or AMF.

The instruction modules may include one or more of initial attach receiving module 315, RAT determination module 325, message generating module 335, attribute assignment module 340, transmittal module 345, subscriber profile update module 350, audit performance module 355, subscriber monitoring module 370, coverage area determination module 365, and/or other instruction modules. Some or all of the sub-modules or units may physically reside within the controller or may instead reside within the memory and/or may be provided as separate units, in any combination. The various sub-modules or units may include or implement logic circuits, thereby performing operations such as monitoring originating RATs and destination RATs for initial attach requests.

While FIG. 3 illustrates the initial attach receiving module 315, RAT determination module 325, message generating module 335, attribute assignment module 340, transmittal module 345, subscriber profile update module 350, audit performance module 355, subscriber monitoring module 370, coverage area determination module 365, as being separate modules, in practical implementations some of the modules may be combined with one another and/or may share components.

The initial attach receiving module 315, RAT determination module 325, message generating module 335, attribute assignment module 340, transmittal module 345, subscriber profile update module 350, audit performance module 355, subscriber monitoring module 370, coverage area determination module 365, may be configured to perform various operations to implement methods in accordance with the present disclosure. While one example of operations performed by the modules is described here, in practical implementations at least some of the operations described as being performed by one module may instead be performed by another module, including a module not explicitly named here.

Initial attach receiving module 315 may be configured to receive an initial attach request from a wireless device. An initial attach process occurs when powering on a UE or UE requests to attach to a network. The UE searches for nearby cells and acquires the synchronization signals (PSS and SSS) to synchronize with access nodes, such as a gNB (gNodeB). Radio resources are established. A registration request for an initial attach is sent from a UE to an AMF to register with the network. After authentication and security setup, the AMF transmits a registration accept message to the UE, confirming successful registration and providing configuration information.

RAT determination module 325 may be configured to determine from the initial attach registration request an originating radio access technology and a destination radio access technology for the initial attach request.

Message generating module 335 may be configured to generate a service based interface (SBI) HTTP2 message for 5G. Attribute assignment module 340 may be configured to assign attributes for the initial attach request including a member, string value and value. The member may be handover type. The string value may be handover. The value may be a full text or unsigned 32 bit integer value. The value may identify the originating RAT and the destination RAT. In the example below, bit integer values are assigned to identify an originating RAT and a destination RAT for a handover type.

For Bit-1, a 5G RAT is identified as the originating RAT and destination RAT for a re-attach on 5G. In this example, the UE was previously attached to 5G but due to inactivity or poor coverage, the UE detached. Subsequently, the UE sends an initial attach request to attach to the 5G RAT and re-attaches to the previous AMF or different AMF either in home or roaming networks.

For Bit-2 a 4G RAT is identified as the originating RAT and the destination RAT is a 5G RAT. In this example, the UE is moving from a 4G LTE RAT to a 5G RAT.

For Bit-3 a 5G RAT is identified as the originating RAT and the destination RAT is a 4G LTE RAT. In this example, the UE is moving from a 5G RAT to a 4G LTE RAT.

For Bit-4 a 5G RAT is identified as the originating RAT and the destination RAT is a 6G RAT. In this example, the UE is moving from a 5G RAT to a 6G RAT.

For Bit-5 a 6G RAT is identified as the originating RAT and the destination RAT is a 5G RAT. In this example, the UE is moving from a 6G RAT to a 5G RAT.

For Bit-6 a 4G RAT is identified as the originating RAT and the destination RAT is a 5G RAT roaming partner network. In this example, the UE is moving from a 4G RAT to a 5G RAT (Roaming).

For Bit-7, a 5G RAT is identified as the originating RAT and the destination RAT is a Roaming Partner LTE network. In this example, the UE is moving from a 5G RAT to a 4G RAT (Roaming).

For Bit-8, a 5G RAT is identified as the originating RAT and the destination RAT is a Roaming Partner 6G RAT network. In this example, the UE is moving from a 5G RAT to a 6G RAT (Roaming).

For Bit-9, a 6G RAT is identified as the originating RAT and the destination RAT is a Roaming Partner 5G RAT network. In this example, the UE is moving from a 6G RAT to a 5G RAT (Roaming).

Bit-10-5G->Non-3GPP WiFi—User moves from LTE to WiFi Network. For Bit-1-, a 6G RAT is identified as the originating RAT and the destination RAT is a Non-3GPP WiFi network. In this example, the UE is moving from a 5G RAT to Non-3GPP WiFi.

For Bit-11, a Non-3GPP WiFi network is identified as the originating RAT and the destination RAT is a 5G RAT a Non-3GPP WiFi network. In this example, the UE is moving from Non-3GPP WiFi to a 5G RAT.

Transmittal module 345 may be configured to transmit the message to a unified data management (UDM) with the of a mobile network operator. The UDM accepts the message and sends data to the unified data repository (UDR).

Subscriber profile update module 350 may be configured to update the subscriber profile for the wireless device maintained in a UDR with corresponding fields for the attributes for the initial attach request. For example, the originating RAT and destination RAT for the initial attach request are maintained in the subscriber profile of the UDR.

Audit performance module 355 may be configured to perform an audit of handovers for a subscriber based on the originating RAT and the destination RAT maintained in the subscriber profile associated with the wireless device.

Subscriber monitoring module 370 may be configured to monitor handovers for a subscriber based on the originating RAT and destination RAT for the initial attach request maintained in the subscriber profile associated with the wireless device.

Coverage area determination module 365 may be configured to utilize the originating RAT and destination RAT maintained in the subscriber profile for determining poor overage areas due to frequent handovers from the originating RAT to the destination rat.

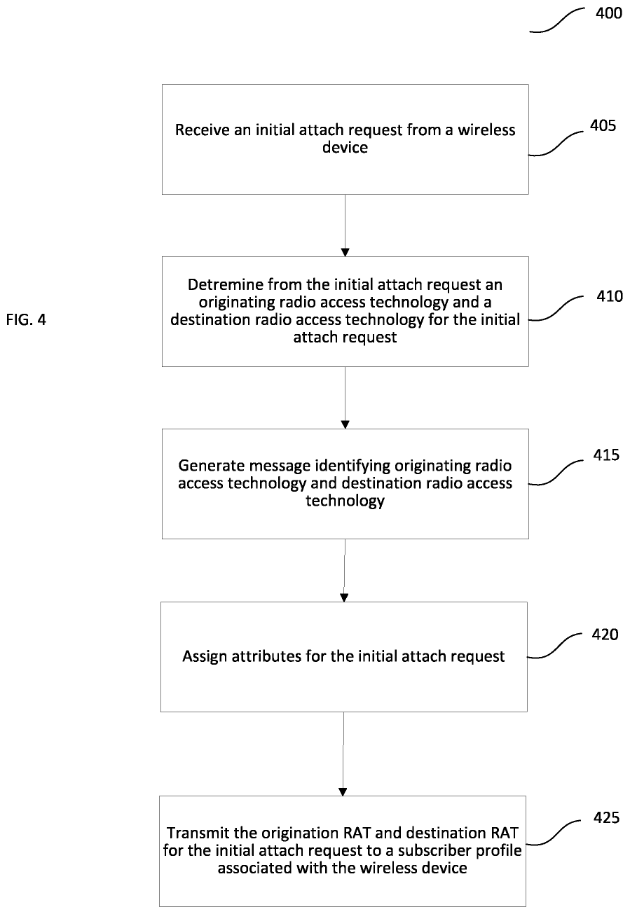

FIG. 4 illustrates an exemplary process flow for transmitting the origination RAT and destination RAT for the initial attach request to a subscriber profile associated with the wireless device. The operations of FIG. 4 will be described as being performed by the tracking engine 310 for purposes of explanation. In other implementations, the operations may be performed by or under the control of a processor of a wireless access node, AMF, 5G core and/or processed in a cloud environment.

The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

The process flow begins at operation 405, an initial attach request from a wireless device is received. An initial attach process occurs when powering on a UE or UE requests to attach to a network. Radio resources are established. A registration request for an initial attach is sent from a UE to an AMF to register with the network.

At operation 410, an originating radio access technology and a destination radio access technology for the initial attach request.

At operation 415, message identifying attributes assigned for originating radio access technology and destination radio access technology is generated. In an example, the message is a SBI HTT2 message with the attributes defined by bit integer values.

At operation 420 attributes for the initial attach request are assigned. In an example, the attributes are bit integer values. Attributes for the initial attach request are assigned including a member, string value and value. The member may be handover type. The string value may be handover. The value may be a full text or unsigned 32 bit integer value. The value may identify the originating RAT and the destination RAT. In an example, bit integer values are assigned to identify an originating RAT and a destination RAT for a handover type.

At operation 425, the generated message with assigned attributes such as bit integer values identifying the originating RAT and destination RAT for the initial attach request is transmitted to a UDM/UDR and maintained in a subscriber profile associated with the wireless device.

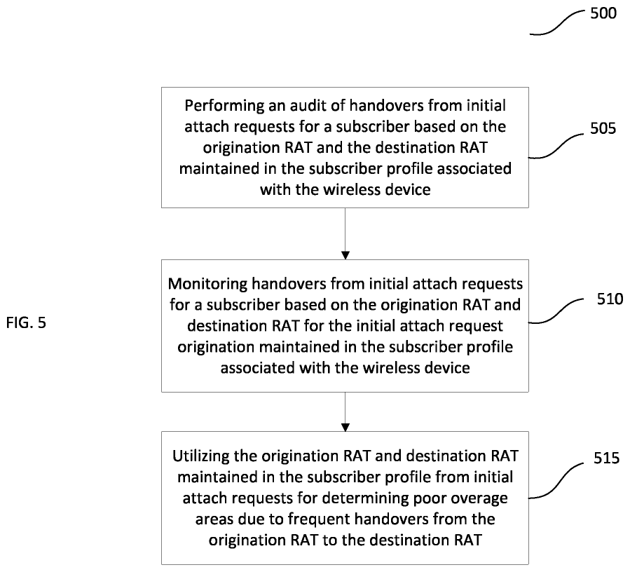

FIG. 5 illustrates a method 500 for utilizing originating RAT and destination RAT data for initial attach requests, in accordance with one or more implementations. The operations of method 500 presented below are intended to be illustrative. In some implementations, method 500 may be accomplished with one or more additional operations not described, and/or without one or more of the operations discussed. Additionally, the order in which the operations of method 500 are illustrated in FIG. 5 and described below is not intended to be limiting.

In some implementations, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At operation 505, an audit of handovers is performed for a subscriber for a UE device based on the originating RAT and the destination RAT maintained in the subscriber profile associated with the wireless device.

At operation 510, handovers are monitored for a subscriber based on the originating RAT and destination RAT for the initial attach request originating maintained in the subscriber profile associated with the wireless device. The monitoring identifies areas to improve UE connections.

At operation 515, utilizing the originating RAT and destination RAT maintained in the subscriber profile for determining poor overage areas due to frequent handovers from the originating RAT to the destination RAT.

The operations need not necessarily be performed one after another in immediate sequence. While the above descriptions illustrate various aspects of the present disclosure, the present disclosure is not so limited. The methods and operations described above may be performed in an iterative matter. These additional iterations may also be reverted in a manner similar to that described above.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention and are intended to be illustrative and not restrictive. Many examples and applications other than the examples provided would be apparent to those skilled in the art upon reading the above description. The scope should be determined, not with reference to the above description, but instead with reference to the appended claims, along with the full scope of equivalents to which such claims are entitled. It is anticipated and intended that future developments will occur in the technologies discussed herein, and that the disclosed systems and methods will be incorporated into future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system, the system comprising:
one or more hardware processors configured by machine-readable instructions to:
receive an initial attach request from a wireless device;
determine from the initial attach request an originating radio access technology (RAT) and a destination radio access technology (RAT) for the initial attach request; and
transmit the originating RAT and destination RAT for the initial attach request to a subscriber profile associated with the wireless device.

2. The system of claim 1, wherein the one or more hardware processors are further configured by machine-readable instructions to generate a service based interface (SBI) HTTP2 message for 5G.

3. The system of claim 2, wherein the one or more hardware processors are further configured by machine-readable instructions to assign attributes for the initial attach request comprising a member, string value and value.

4. The system of claim 3, wherein the one or more hardware processors are further configured by machine-readable instructions to transmit the SBI HTTP2 message to a unified data management of a mobile network operator.

5. The system of claim 4, wherein the one or more hardware processors are further configured by machine-readable instructions to update the subscriber profile for the wireless device maintained in a unified data repository with corresponding fields for the attributes for the initial attach request.

6. The system of claim 3, wherein the member is handover type.

7. The system of claim 6, wherein the string value is handover.

8. A method, the method comprising:
receiving an initial attach request from a wireless device;
determining from the initial attach request an originating radio access technology (RAT) and a destination radio access technology (RAT) for the initial attach request; and
transmitting the originating RAT and destination RAT for the initial attach request to a subscriber profile associated with the wireless device.

9. The method of claim 8, generating a service based interface (SBI) HTTP2 message for 5G.

10. The method of claim 9, assigning attributes for the initial attach request comprising a member, string value and value.

11. The method of claim 10, further comprising transmitting the SBI HTTP2 message to a unified data management of a mobile network operator.

12. The method of claim 11, further comprising, updating the subscriber profile for the wireless device maintained in a unified data repository with corresponding fields for the attributes for the initial attach request.

13. The method of claim 10, wherein the member is handover type.

14. The method of claim 13, wherein the string value is handover.

15. A non-transient computer-readable storage medium having instructions embodied thereon, the instructions being executable by one or more processors to perform a method, the method comprising:
receiving an initial attach request from a wireless device;
determining from the initial attach request an originating radio access technology and a destination radio access technology for the initial attach request; and
transmitting the originating RAT and destination RAT for the initial attach request to a subscriber profile associated with the wireless device.

16. The computer-readable storage medium of claim 15, wherein the method generating a service based interface HTTP2 message for 5G.

17. The computer-readable storage medium of claim 16, wherein the method comprises assigning attributes for the initial attach request comprises a member, string value and value.

18. The computer-readable storage medium of claim 17, wherein the value identifies the originating RAT and the destination RAT.

19. The computer-readable storage medium of claim 15, further comprising: performing an audit of handovers for a subscriber based on the origination RAT and the destination RAT maintained in the subscriber profile associated with the wireless device.

20. The computer-readable storage medium of claim 15, further comprising: utilizing the origination RAT and destination RAT maintained in the subscriber profile for determining poor overage areas due to frequent handovers from the origination RAT to the destination RAT.
